(19) United States
(12) Patent Application Publication
(10) Pub. No.: US 2016/0211504 A1
(43) Pub. Date: Jul. 21, 2016

(54) METHOD OF MANUFACTURING ELECTRODE

(71) Applicant: TOYOTA JIDOSHA KABUSHIKI KAISHA, Toyota-shi (JP)

(72) Inventors: Tomoyuki UEZONO, Toyota-shi (JP); Katsushi ENOKIHARA, Toyota-shi (JP)

(73) Assignee: TOYOTA JIDOSHA KABUSHIKI KAISHA, Toyota-shi (JP)

(21) Appl. No.: 14/994,350

(22) Filed: Jan. 13, 2016

(30) Foreign Application Priority Data
Jan. 19, 2015 (JP) 2015-007739

(51) Int. Cl. H01M 4/04; H01M 4/62

(52) U.S. Cl. CPC H01M 4/0404; H01M 4/62; H01M 4/0409

(57) ABSTRACT

A method of manufacturing an electrode includes: forming wet granules; and forming an electrode mixture layer on an electrode current collector by rolling the formed wet granules. When the wet granules are formed, a conductive material and fine particles having a primary particle diameter of 20 nm or smaller are stirred and mixed with each other, and the stirred mixture and an electrode active material are stirred and mixed with each other. During the stirring when the wet granules are formed, a peripheral speed of a stirring blade included in a stirrer is 10 m/s or higher.

### INCORPORATION BY REFERENCE

The disclosure of Japanese Patent Application No. 2015-007739 filed on Jan. 19, 2015 including the specification, drawings and abstract is incorporated herein by reference in its entirety.

### BACKGROUND OF THE INVENTION

1. Field of the Invention

The present invention relates to a method of manufacturing an electrode.

2. Description of Related Art

A non-aqueous electrolyte secondary battery such as a lithium-ion secondary battery is used in a hybrid vehicle (HV), a plug-in hybrid vehicle (PHV), an electric vehicle (EV), or the like. The non-aqueous electrolyte secondary battery includes a positive electrode and a negative electrode, which form a pair of electrodes, a separator which insulates the electrodes from each other, and a non-aqueous electrolyte. As the structure of the electrode (the positive electrode or the negative electrode) for the non-aqueous electrolyte secondary battery, a structure including an electrode current collector formed of a metal foil or the like, and an electrode mixture layer which is formed thereon and contains an electrode active material is known.

In Japanese Patent Application Publication No. 2007-305546 (JP 2007-305546 A), a technique in which a positive electrode mixture layer containing ceramic particles (nanoparticles) is used as a positive electrode mixture layer that forms the positive electrode of a lithium-ion secondary battery, is disclosed. In the technique disclosed in JP 2007-305546 A, the content of the ceramic particles (having a median diameter of 50 nm or smaller) in the positive electrode mixture layer is equal to or higher than 0.1 parts by weight and equal to or lower than 1.0 parts by weight with respect to 100 parts by weight of a positive electrode active material. In addition, in the technique disclosed in JP 2007-305546 A, when the positive electrode is manufactured, the positive electrode active material, the ceramic particles, a binding material, and a conductive material are uniformly mixed into a positive electrode mixture, and the positive electrode mixture is dispersed in a solvent to have a slurry form. The slurry is uniformly applied to both surfaces of a positive electrode current collector by a doctor blade method or the like.

As one of techniques for manufacturing an electrode of a non-aqueous electrolyte secondary battery, there is a technique for forming an electrode mixture layer on an electrode current collector by rolling wet granules. In this technique, the wet granules are supplied between a first roll and a second roll (see a first roll 21 and a second roll 22 in FIG. 4) that rotate in opposite directions to each other, and the wet granules are allowed to adhere to the first roll while being rolled, thereby forming an electrode mixture layer. The formed electrode mixture layer is transferred onto the electrode current collector, and accordingly, an electrode in which the electrode mixture layer is disposed on the electrode current collector is formed (details of this technique will be described later).

As described above, in the method of forming the electrode mixture layer by supplying the wet granules between the two rolls and rolling the wet granules, in a case where the malleability of the wet granules is low, there is a possibility that pinholes, streaks, and the like may be generated in the electrode mixture layer formed through the rolling.

### SUMMARY OF THE INVENTION

According to an aspect of the present invention, the malleability of wet granules is enhanced, and thus the generation of pinholes or streaks in an electrode mixture layer formed by rolling the wet granules is prevented.

A method of manufacturing an electrode according to an aspect of the present invention includes: forming wet granules by mixing a conductive material, an electrode active material, a binding material, and a solvent; and forming an electrode mixture layer on an electrode current collector by rolling the wet granules. When the wet granules are formed, the conductive material and fine particles having a primary particle diameter of 20 nm or smaller are stirred and mixed with each other, and the stirred mixture and the electrode active material are stirred and mixed with each other. During the stirring when the wet granules are formed, a peripheral speed of a stirring blade included in a stirrer is 10 m/s or higher.

In the method of manufacturing an electrode according to the aspect of the present invention, when the wet granules are formed, the fine particles having a primary particle diameter of 20 nm or smaller are added. The fine particles act as a lubricant between the particles of the electrode active material, and thus can enhance the malleability of the wet granules. At this time, in the method of manufacturing an electrode according to the aspect of the present invention, since the conductive material and the fine particles are stirred, and thereafter the electrode active material is added thereto and stirred, simultaneous application of strong shear stress to the electrode active material and the fine particles can be prevented. Therefore, infiltration of the fine particles into uneven portions of the surface of the electrode active material is prevented, and thus the fine particles can be uniformly dispersed on the surface of the electrode active material. In addition, in the method of manufacturing an electrode according to the aspect of the present invention, since the peripheral speed of the stirring blade is 10 m/s or higher, the fine particles can be uniformly dispersed on the surface of the electrode active material. As described above, in the method of manufacturing an electrode according to the aspect of the present invention, since the fine particles can be uniformly dispersed on the surface of the electrode active material, the malleability of the wet granules can be enhanced. Accordingly, when the electrode mixture layer is formed by rolling the wet granules, the generation of pinholes or streaks in the electrode mixture layer can be prevented.

According to the aspect of the present invention, the generation of pinholes or streaks in the electrode mixture layer formed by rolling the wet granules can be prevented.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a flowchart illustrating a method of manufacturing an electrode according to an embodiment;

FIG. 2 is a flowchart illustrating a process of forming wet granules;

FIG. 3 is a view illustrating an example of a stirrer;

FIG. 4 is a perspective view illustrating an example of an electrode manufacturing apparatus used when an electrode mixture layer is formed on an electrode current collector;

FIG. 5 is a view illustrating an effect of the present invention;

FIG. 6 is a flowchart illustrating a process of forming wet granules according to a comparative example;

FIG. 7 is Table 1 in which the malleability and film-forming properties of Samples, in which the type and primary particle diameter of fine particles vary, are shown;

FIG. 8 is Table 2 in which the malleability, film-forming properties, and cell IV characteristic of Samples 10 and 14 to 19, in which the amount of the added fine particles varies, are shown;

FIG. 9 is Table 3 in which the malleability and film-forming properties of Samples 10 and 20 to 22, in which a stirring speed (the peripheral speed of stirring blades) in a first stirring process (Step S11) varies, are shown; and

FIG. 10 is Table 4 in which the malleability, film-forming properties, and cell IV characteristic of Samples manufactured by dividing a stirring process into the first stirring process and a second stirring process, and Sample with a stirring process that is not divided, are shown.

### DETAILED DESCRIPTION OF EMBODIMENTS

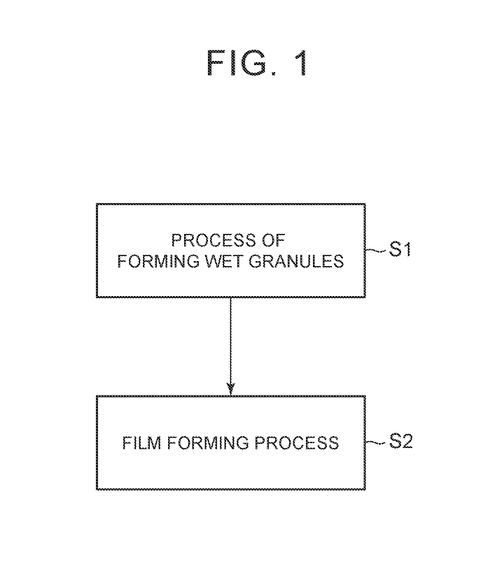

Hereinafter, an embodiment of the present invention will be described with reference to the drawings. FIG. 1 is a flowchart illustrating a method of manufacturing an electrode according to the embodiment. The method of manufacturing an electrode according to the embodiment may be used to manufacture an electrode (a positive electrode and a negative electrode) of a non-aqueous electrolyte secondary battery such as a lithium-ion secondary battery.

As illustrated in FIG. 1, when the electrode is manufactured, wet granules are formed by mixing at least a conductive material, an electrode active material, a binding material, and a solvent (Step S1). Thereafter, the wet granules formed in Step S1 are rolled, thereby forming an electrode mixture layer on an electrode current collector (Step S2).

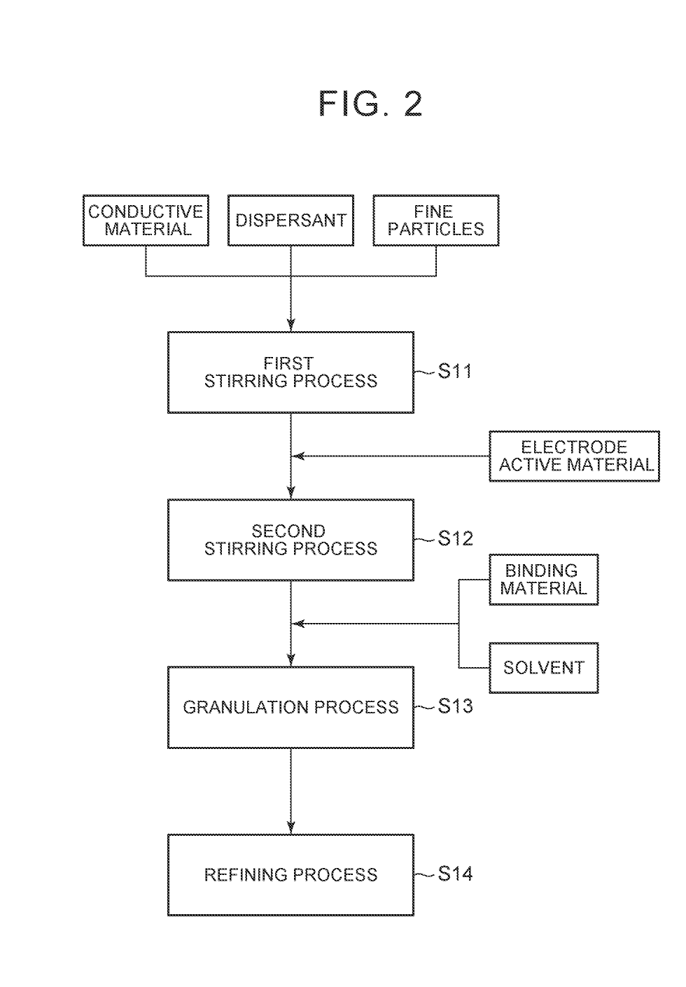

First, a process (Step S1) of forming the wet granules will be described in detail. FIG. 2 is a flowchart illustrating the process of forming the wet granules. Hereinafter, a method of manufacturing wet granules for a positive electrode will be described. However, wet granules for a negative electrode may also be manufactured by using the same method.

First, as illustrated in FIG. 2, the conductive material, a dispersant, and fine particles are poured into a stirrer and are dry-stirred (Step S11: first stirring process). Here, as the conductive material, for example, acetylene black (AB), carbon black such as Ketjen Black, or graphite may be used. For example, the primary particle diameter of the conductive material (AB) is about 50 nm, and the secondary particle thereof is about 300 nm. As the dispersant, carboxymethylcellulose sodium salt (CMC) or the like may be used. In the method of manufacturing an electrode according to this embodiment, the addition of the dispersant may be omitted.

As the fine particles, for example, ceramic particles such as alumina, silica, and titania may be used. In consideration of the effect of the reaction between the fine particles and an electrolyte, alumina particles are particularly preferably used. That is, by using the alumina particles as the fine particles, the reaction between the fine particles and the electrolyte can be prevented, and thus the degradation of battery characteristics can be prevented. For example, the primary particle diameter of the fine particles is 20 nm or smaller. In addition, the amount of the added fine particles may be 0.05 wt % or more and 1 wt % or less with respect to the electrode active material (positive electrode active material).

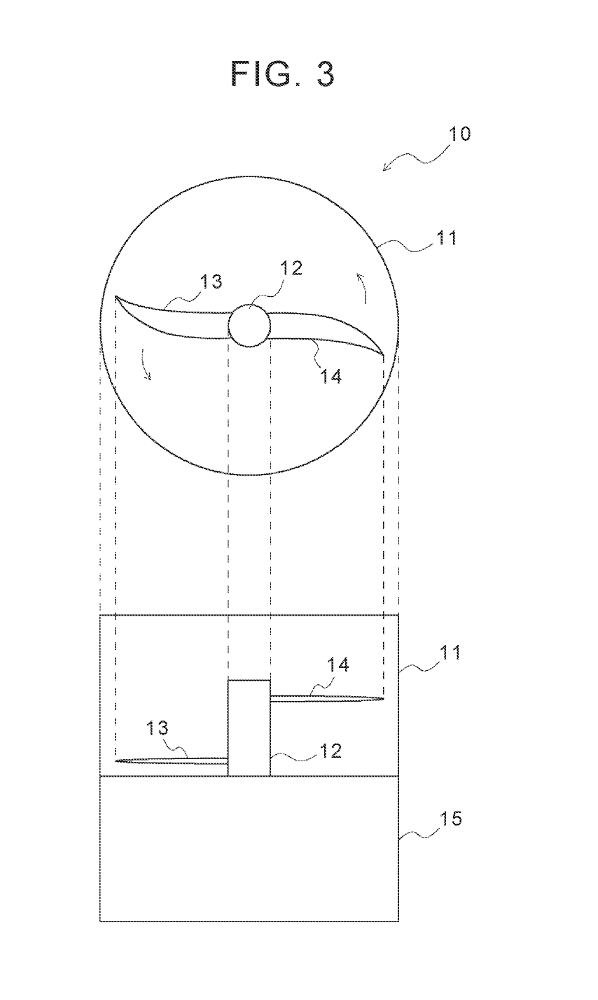

FIG. 3 is a plan view (upper figure) and a side view (lower figure) illustrating an example of the stirrer used in the method of manufacturing an electrode according to this embodiment. As illustrated in FIG. 3, a stirrer 10 includes a stirring container 11, a rotating shaft 12, stirring blades 13, 14, and a body section 15. A stirring object (the conductive material, the dispersant, and the fine particles) is poured into the stirring container 11. The rotating shaft 12 is connected to a rotating mechanism (not illustrated), and is configured to rotate during stirring. The stirring blades 13, 14 are attached to the rotating shaft 12 so as to extend from the rotating shaft 12 toward an outer peripheral direction. As illustrated in the lower figure of FIG. 3, the stirring blade 13 and the stirring blade 14 are attached to the rotating shaft 12 so as to have different positions in a vertical direction. In the body section 15, the rotating mechanism (motor) for rotating the rotating shaft 12, a control circuit, and the like are accommodated.

In this embodiment, when the conductive material, the dispersant, and the fine particles are dry-stirred, the peripheral speed of the stirring blades 13, 14 included in the stirrer 10 is 10 m/s or higher. In addition, the stirring time may be, for example, about 120 seconds, but is not limited thereto. Here, the peripheral speed of the stirring blades 13, 14 is a speed at the tip ends of the stirring blades 13, 14 (that is, a speed of the outer peripheries of the stirring blades 13, 14), and can be obtained from the length of the stirring blades and the number of rotations of the stirring blades per unit time. That is, the peripheral speed can be obtained by using the following expression. In the following expression, “length of stirring blade” is the length from the center of the rotating shaft 12 to the tip end of the stirring blade 13 (or the stirring blade 14).

peripheral speed (m/s)=length (mm) of stirring blade×2×π×number of rotations (rpm)÷1000÷60

The stirrer 10 illustrated in FIG. 3 is an example, and a stirrer having a configuration other than that illustrated in FIG. 3 may also be used in the method of manufacturing an electrode according to this embodiment. For example, the number of stirring blades included in the stirrer 10 may be three or more.

In Step S11, the conductive material, the dispersant, and the fine particles are poured into the stirrer, and the peripheral speed of the stirring blades during the stirring is 10 m/s or higher such that the conductive material (AB) is crushed and the structure of the fine particles is decomposed. Therefore, the fine particles and the conductive material (AB) can be uniformly mixed with each other. At this time, a portion of the fine particles adheres to the surface of the conductive material (AB).

Next, the mixture (the conductive material, the dispersant, and the fine particles) stirred in Step S11 and the electrode active material (the positive electrode active material) are stirred and mixed with each other (Step S12: second stirring process). The positive electrode active material is a material which enables occlusion and discharge of lithium, and for example, lithium cobaltate (LiCoO₂), lithium manganate (LiMn₂O₄), or lithium nickelate (LiNiO₂) may be used. Otherwise, a material obtained by mixing LiCoO₂, LiMn₂O₄, and LiNiO₂ in arbitrary proportions and baking the mixture may also be used. As an example of the composition thereof, for example, LiNi_{1/3}Mn_{1/3}Co_{1/3}O₂ obtained by mixing the materials in the same proportion may be employed. The secondary particle diameter of the electrode active material (the positive electrode active material) is, for example, about 5 μm.

Even during the stirring in Step S12, the peripheral speed of the stirring blades 13, 14 included in the stirrer 10 is also 10 m/s or higher. In addition, the stirring time may be, for example, about 15 seconds, and is not limited thereto.

In Step S12, by stirring the mixture (the conductive material, the dispersant, and the fine particles) and the positive electrode active material, the conductive material (AB) and the fine particles may be allowed to adhere to the periphery of the positive electrode active material. Particularly in this embodiment, by setting the peripheral speed of the stirring blades during the stirring to 10 m/s or higher, the fine particles can be allowed to be uniformly dispersed in the periphery of the positive electrode active material.

Next, the binding material and the solvent are added to the mixture (the conductive material, the dispersant, the fine particles, and the positive electrode active material) stirred in Step S12 and the resultant is stirred for granulation (Step S13: granulation process). As the binding material, for example, polyvinylidene fluoride (PVDF), styrene-butadiene rubber (SBR), or polytetrafluoroethylene (PTFE) may be used. As the solvent, for example, water or an N-methyl-2-pyrrolidone (NMP) solution may be used.

In Step S13, it is preferable that the peripheral speed of the stirring blades during the stirring is 10 m/s or lower (low-speed stirring). Accordingly, the adhesion of the wet granules to the stirring container 11 is prevented, and thus the yield is enhanced. The stirring time may be, for example, about 15 seconds, and is not limited thereto.

Next, in order to refine the granules granulated in Step S13, stirring is performed at a faster peripheral speed for a shorter amount of time than during the stirring in Step S13 (Step S14: refining process). For example, the peripheral speed of the stirring blades during the stirring is about 15 m/s (high-speed stirring), and the stirring time is about 3 seconds.

By using the above-described method, the wet granules for the positive electrode can be manufactured. In addition, wet granules for the negative electrode can be manufactured by using the same method as the above-described method. When the wet granules for the negative electrode are manufactured, a negative electrode active material is used as the electrode active material.

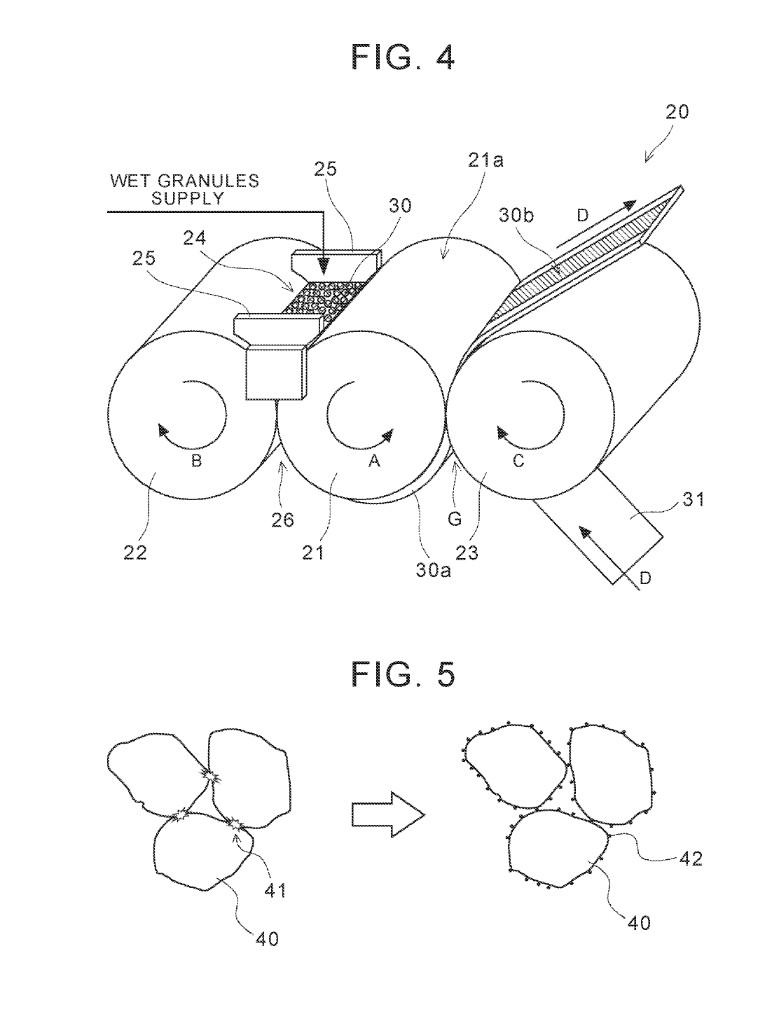

Next, a film forming process (Step S2) of FIG. 1, that is, the process of forming the electrode mixture layer on the electrode current collector by rolling the wet granules formed in Step S1 will be described in detail. FIG. 4 is a perspective view illustrating an example of an electrode manufacturing apparatus used in the film forming process.

As illustrated in FIG. 4, an electrode manufacturing apparatus 20 includes an application roll 21 (first roll), a drawing roll 22 (second roll), a transfer roll 23, and a storage portion 24 which stores wet granules 30. The application roll 21 is provided between the drawing roll 22 and the transfer roll 23. The storage portion 24 is provided between the application roll 21 and the drawing roll 22. In addition, the application roll 21 and the drawing roll 22 face each other, and a clearance 26 (gap) is provided between the application roll 21 and the drawing roll 22. Accordingly, the clearance 26 can be provided below the storage portion 24. The storage portion 24 includes a pair of blades 25, and by adjusting the interval between the pair of blades 25, the application width of an electrode mixture layer 30b applied onto an electrode current collector 31 can be specified.

The application roll 21 rotates in an arrow A direction (counterclockwise in FIG. 4). The drawing roll 22 rotates in an arrow B direction (clockwise in FIG. 4). That is, a rotational direction of the drawing roll 22 is opposite to a rotational direction of the application roll 21. In addition, the transfer roll 23 rotates in a arrow C direction (clockwise in FIG. 4). That is, a rotational direction of the transfer roll 23 is opposite to the rotational direction of the application roll 21. For example, the rotational speed of the application roll 21 is faster than that of the drawing roll 22, and the rotational speed of the transfer roll 23 is faster than that of the application roll 21.

The drawing roll 22 draws and rolls the wet granules 30 stored in the storage portion 24 in a downward direction in cooperation with the application roll 21. That is, as the application roll 21 and the drawing roll 22 rotate, the wet granules 30 stored in the storage portion 24 are extruded from the clearance 26 in the downward direction while being rolled. At this time, the rolled wet granules 30, that is, an electrode mixture layer 30a adheres to the surface of the application roll 21. The application roll 21 holds the adhered electrode mixture layer 30a on a roll surface 21a. The application roll 21 rotates in the arrow A direction while holding the electrode mixture layer 30a, thereby transporting the electrode mixture layer 30a to the transfer roll 23 side.

On the other hand, the transfer roll 23 transports the electrode current collector 31, which is a metal foil, for example, in an arrow D direction by rotating in the arrow C direction. When the electrode mixture layer 30a is transported to a gap G between the application roll 21 and the transfer roll 23 by the application roll 21, the application roll 21 applies (transfers) the electrode mixture layer 30a onto the electrode current collector 31 at the gap G in cooperation with the transfer roll 23. Thereafter, the electrode mixture layer 30b transferred to the electrode current collector 31 is transported in a drying process (not illustrated) and is dried. Accordingly, the electrode mixture layer 30b can be formed on the electrode current collector 31.

When the positive electrode is manufactured by using the electrode manufacturing apparatus 20, wet granules containing the positive electrode active material are used as the wet granules 30, and a positive electrode current collector is used as the electrode current collector. As the positive electrode current collector, for example, aluminum or an alloy primarily containing aluminum may be used. When the negative electrode is manufactured by using the electrode manufacturing apparatus 20, wet granules containing the negative electrode active material are used as the wet granules 30, and a negative electrode current collector is used as the electrode current collector. As the negative electrode current collector, for example, copper, nickel, or an alloy thereof may be used.

As in the electrode manufacturing apparatus 20 illustrated in FIG. 4, in a method of forming the electrode mixture layer by supplying the wet granules 30 between the two rolls 21, 22 and rolling the wet granules 30, in a case where the malleability of the wet granules 30 is low, there is a possibility that pinholes, streaks, and the like may be generated in the electrode mixture layer 30b formed through the rolling.

Here, in the method of manufacturing an electrode according to this embodiment, when the wet granules are formed (Step S1 in FIG. 1), the fine particles having a primary particle diameter of 20 nm or smaller are added. The fine particles act as a lubricant between the particles of the electrode active material, and thus can enhance the malleability of the wet granules. That is, as illustrated in the left figure of FIG. 5, in a case of not adding fine particles, when particles of the electrode active material 40 come into contact with each other, friction resistance is generated between the particles of the electrode active material 40 (indicated by reference numeral 41), and thus the malleability of the wet granules containing the electrode active material 40 is reduced. On the other hand, in the case of adding the fine particles as in this embodiment, as illustrated in the right figure of FIG. 5, fine particles 42 act as a lubricant between the particles of the electrode active material 40 (in other words, the fine particles 42 act as a bearing), and thus the malleability of the wet granules can be enhanced.

Furthermore, in the method of manufacturing an electrode according to this embodiment, when the wet granules are formed, as illustrated in FIG. 2, the conductive material and the fine particles are stirred in the first stirring process (Step S11), and thereafter the electrode active material is added thereto and stirred in the second stirring process (Step S12). Therefore, simultaneous application of strong shear stress to the electrode active material and the fine particles can be prevented. Therefore, infiltration of the fine particles into uneven portions of the surface of the electrode active material is prevented, and thus the fine particles can be uniformly dispersed on the surface of the electrode active material.

In the technique disclosed in JP 2007-305546 A described as the related art, ceramic particles (nanoparticles) are added to the positive electrode mixture layer. However, in the technique according to JP 2007-305546 A, when the positive electrode is manufactured, the positive electrode mixture is formed by simultaneously mixing the positive electrode active material, the ceramic particles, the binding material, and the conductive material, and thus the fine particles infiltrate into uneven portions of the surface of the positive electrode active material when the materials are mixed with each other. Therefore, the fine particles cannot be uniformly dispersed in the periphery of the positive electrode active material. Therefore, even when the technique according to JP 2007-305546 A is used, the effect of the present invention described above (enhancement in malleability) is not obtained. This point is described in detail through comparison between Sample 16 and Sample 23 (see Table 4 of FIG. 10) in Examples.

In addition, in the method of manufacturing an electrode according to this embodiment, since the peripheral speed of the stirring blades is 10 m/s or higher, the crushing of the conductive material and the decomposition of the structure of the fine particles can be accelerated in the first stirring process (Step S11), and the fine particles can be uniformly dispersed on the surface of the electrode active material in the second stirring process (Step S12). As described above, since the fine particles can be uniformly dispersed on the surface of the electrode active material, the malleability of the wet granules can be enhanced. Accordingly, when the electrode mixture layer is formed by rolling the wet granules, the generation of pinholes, streaks, and the like in the electrode mixture layer can be prevented.

At this time, by setting the primary particle diameter of the added fine particles to 20 nm or smaller, the fine particles can easily infiltrate between the electrode active material and the electrode active material (see FIG. 5), resulting in a significant reduction in the friction resistance between the particles of the electrode active material. Therefore, the malleability of the wet granules can be significantly enhanced.

It is preferable that the amount of the added fine particles is 0.05 wt % or more and 1 wt % or less with respect to the electrode active material. By allowing the amount of the added fine particles to be 0.05 wt % or more with respect to the electrode active material, the fine particles can be allowed to act as a lubricant between the particles of the electrode active material, and thus an effect of reducing the friction resistance between the particles of the electrode active material (that is, enhancing malleability) is obtained. In addition, by allowing the amount of the added fine particles to be 1 wt % or less with respect to the electrode active material, an increase in resistance components in the battery can be suppressed. Particularly, in consideration of the effect of enhancing malleability and the suppression of battery resistance, it is more preferable that the amount of the added fine particles is 0.1 wt % or more and 0.5 wt % or less with respect to the electrode active material.

In the method of manufacturing an electrode according to this embodiment, it is more preferable that the peripheral speed of the stirring blades in the first stirring process (Step S11) and the second stirring process (Step S12) is 15 m/s or higher. Accordingly, the fine particles can be more uniformly dispersed on the surface of the electrode active material. In this embodiment, the upper limit of the peripheral speed of the stirring blades may be 40 m/s.

By the invention according to this embodiment described above, the generation of pinholes and streaks in the electrode mixture layer formed by rolling the wet granules can be prevented.

Next, Examples of the present invention will be described. Wet granules were manufactured by using the method described above. LiNi_{1/3}Co_{1/3}Mn_{1/3}O₂ was used as the electrode active material (positive electrode active material), and acetylene black (Denka Black HS-100 manufactured by Denka Company Limited.) was used as the conductive material. Furthermore, carboxymethylcellulose sodium salt (CMC) (MAC800LC manufactured by Nippon Paper Industries Co., Ltd.) as the dispersant, and an acrylic polymer (manufactured by JSR Corporation) containing a fluoropolymer as the binding material were added. As the solvent, ion-exchange water was used.

As the fine particles, any of SiO₂ (product number: NAX50, NX90G, R972, 300, R976, and RX300), TiO₂ (product number: P25, P90, T805, and NKT90), and Al₂O₃ (product number: AluC and AluC805) was used (all of which are manufactured by Nippon Aerosil Co., Ltd.).

In terms of solid content, the content of the electrode active material was (91-x) wt %, the content of the conductive material was 8 wt %, the content of the dispersant was 0.5 wt %, the content of the binding material was 0.5 wt %, and the content of the fine particles was x wt %. Here, the solid content fraction of the fine particles was x. The solid content fraction of the wet granules was 75 wt %.

As the stirrer for manufacturing the wet granules, a food processor (MB-MM22 manufactured by Yamamoto Electric Corporation) was used. When the wet granules were manufactured, first, as illustrated in FIG. 2, the conductive material, the dispersant, and the fine particles were poured into the stirrer, and were dry-stirred under the conditions of a peripheral speed of the stirring blades of 10 m/s and a time of 120 seconds (Step S11). Thereafter, the electrode active material was poured into the stirrer and was dry-stirred under the conditions of a peripheral speed of the stirring blades of 10 m/s and a time of 15 seconds (Step S12). The binding material and water were then poured into the stirrer and were stirred for granulation under the conditions of a peripheral speed of the stirring blades of 10 m/s and a time of 15 seconds (Step S13). Finally, in order to refine the granules granulated in Step S13, stirring was performed thereon under the conditions of a peripheral speed of the stirring blades of 15 m/s and a time of 3 seconds (Step S14).

The malleability of the obtained wet granules was evaluated using a malleability evaluation apparatus manufactured by Rix Corporation. The malleability evaluation apparatus is an apparatus which allows a predetermined amount of the wet granules to be interposed between a plate material and a wedge material, narrows the film thickness of the wet granules by gradually pressing the wedge material, and measures the load at the predetermined film thickness. In this example, the load on the wet granules at a film thickness of 350 μm was measured. A case of a load of lower than 1 kN was evaluated as “good”, and a case of a load of 1 kN or higher was evaluated as “unavailable”.

In addition, by using the electrode manufacturing apparatus illustrated in in FIG. 4, an electrode was manufactured from the wet granules. An aluminum foil was used as the electrode current collector. Regarding film-forming properties, the absence or presence of pinholes, streaks, or the like on the formed electrode mixture layer was visually evaluated. The absence of pinholes or streaks was evaluated as “good”, and the presence of pinholes or streaks was evaluated as “unavailable”.

In addition, a lithium-ion secondary battery cell was manufactured by using the positive electrode formed as described above. The reactive resistance (IV characteristic) of the impedance of the battery cell at 25° C. and SOC=56% was measured. In a case where the IV characteristic thereof was lower than 200 mΩ, the case was evaluated as “good”. In a case where the IV characteristic thereof was 200 mΩ or higher, the case was evaluated as “unavailable”.

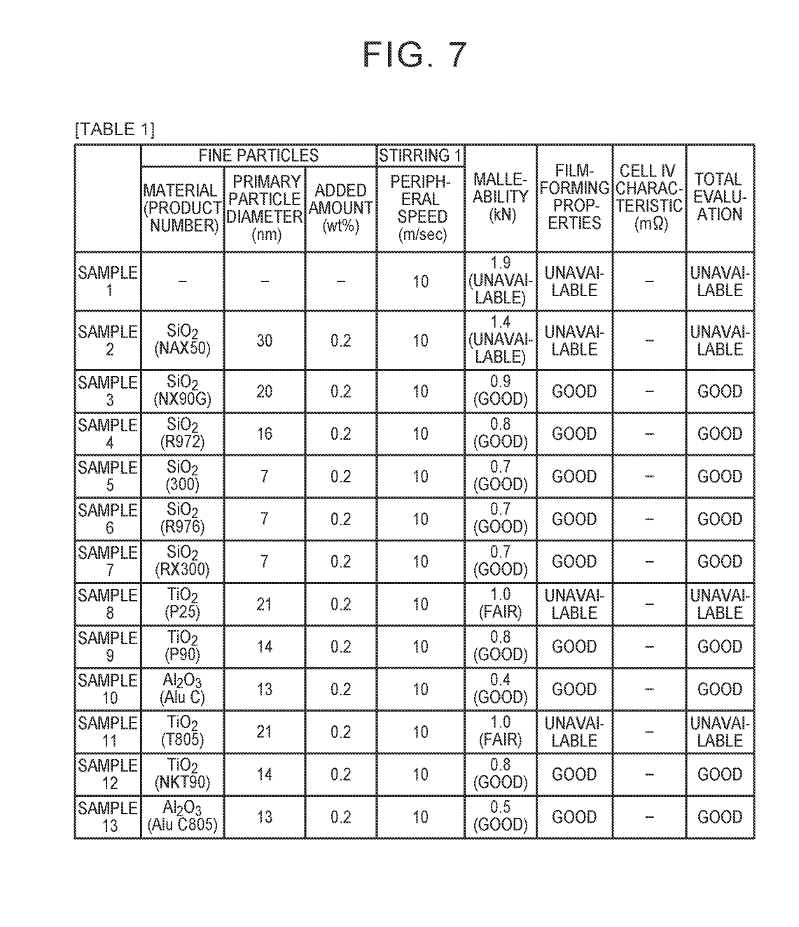

In Table 1 of FIG. 7, the malleability and film-forming properties of Samples in which the type and primary particle diameter of the fine particles vary are shown. As the evaluation in Tables in this specification, “good”, “unavailable”, and “fair (an evaluation of being in between good and unavailable)” are shown. In Samples 1 to 13, while the amount of the added fine particles and the stirring speed (the peripheral speed of the stirring blades) in the first stirring process (Step S11) were fixed, the type of the added fine particles and the primary particle diameter thereof were changed.

Sample 1 is a sample in which the fine particles were not added. Samples 2 to 7 are samples in which SiO₂ was used as the fine particles. The primary particle diameter of the fine particles added in Sample 2 was 30 nm, the primary particle diameter of the fine particles added in Sample 3 was 20 nm, the primary particle diameter of the fine particles added in Sample 4 was 16 nm, and the primary particle diameter of the fine particles added in Samples 5 to 7 was 7 nm. In addition, the product numbers of the fine particles added in Samples 5 to 7 were different from each other.

Samples 8, 9, 11, and 12 are samples in which TiO₂ was used as the fine particles. The primary particle diameter of the fine particles added in Samples 8 and 11 was 21 nm, and the primary particle diameter of the fine particles added in Samples 9 and 12 was 14 nm. In addition, the product numbers of the fine particles added in Samples 8, 9, 11, and 12 were different from each other.

Samples 10 and 13 are samples in which Al₂O₃ was used as the fine particles. The primary particle diameter of the fine particles added in Samples 10 and 13 was 13 nm. In addition, the product numbers of the fine particles added in Samples 10 and 13 were different from each other.

As shown in Table 1 of FIG. 7, since the fine particles were not added in Sample 1, the malleability of the wet granules was reduced due to the friction resistance between the particles of the electrode active material (that is, the load at a film thickness of 350 μm was increased). Therefore, during the film formation, pinholes or streaks were generated in the electrode mixture layer. In addition, although the fine particles were added in Samples 2, 8, and 11, since the primary particle diameter of the added fine particles was 20 nm or greater, an effect of enhancing the malleability of the wet granules was low, and the film-forming properties were evaluated as unavailable. In Samples 3 to 7, 9, 10, 12, and 13 other than the above samples, the primary particle diameter of the fine particles was 20 nm or smaller, and the malleability of the wet granules was enhanced by the addition of the fine particles. Therefore, the film-forming properties were good.

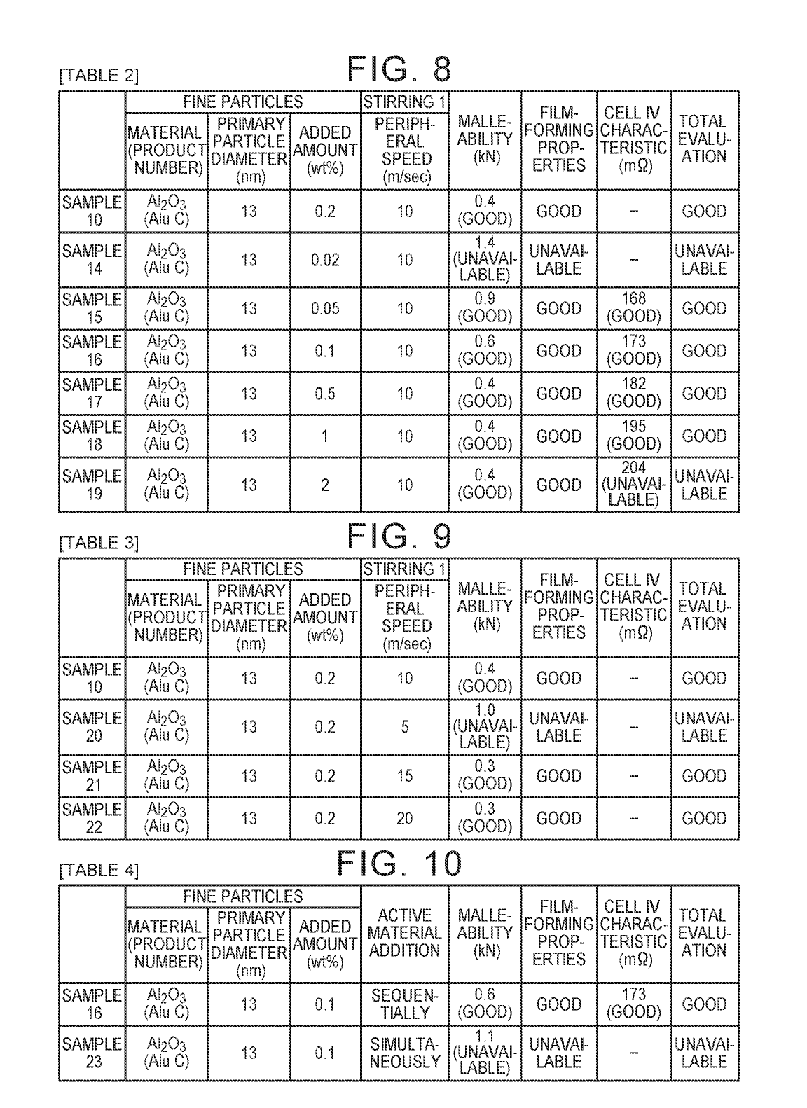

In Table 2 of FIG. 8, the malleability, film-forming properties, and cell IV characteristic of Samples 10 and 14 to 19 in which the amount of the added fine particles varies are shown. In Samples 10 and 14 to 19, while the type of the fine particles and the stirring speed (the peripheral speed of the stirring blades) in the first stirring process (Step S11) were fixed, the amount of the added fine particles was changed.

As shown in Table 2 of FIG. 8, in Sample 14, since the amount of the added fine particles was less than 0.05 wt % with respect to the electrode active material and thus the added amount was small, an effect of enhancing the malleability of the wet granules was low, and the film-forming properties were evaluated as unavailable. In addition, in Sample 19, since the amount of the added fine particles was more than 1 wt % with respect to the electrode active material, although the malleability of the wet granules was enhanced, the reactive resistance of the battery was increased. From the results shown in Table 2 of FIG. 8, it can be said that it is preferable that the amount of the added fine particles is 0.05 wt % or more and 1 wt % or less with respect to the electrode active material. Particularly, in consideration of the effect of enhancing malleability and the suppression of battery resistance, it can be said that it is more preferable that the amount of the added fine particles is 0.1 wt % or more and 0.5 wt % or less with respect to the electrode active material.

In Table 3 of FIG. 9, the malleability and film-forming properties of Samples 10 and 20 to 22 in which the stirring speed (the peripheral speed of the stirring blades) in the first stirring process (Step S11) varies are shown. In Samples 10 and 20 to 22, while the type of the fine particles and the added amount thereof were fixed, the stirring speed (the peripheral speed of the stirring blades) in the first stirring process (Step S11) was changed.

As shown in Table 3 of FIG. 9, in Sample 20, since the stirring speed (the peripheral speed of the stirring blades) in the first stirring process (Step S11) was lower than 10 m/s, the fine particles were not uniformly dispersed in the periphery of the electrode active material. Therefore, an effect of enhancing the malleability of the wet granules was low, and the film-forming properties were evaluated as unavailable. In Samples other than the above Samples, the malleability of the wet granules was enhanced, and the film-forming properties were good. From the results shown in Table 3 of FIG. 9, it can be said that it is preferable that the stirring speed (the peripheral speed of the stirring blades) in the first stirring process (Step S11) is 10 m/s or higher.

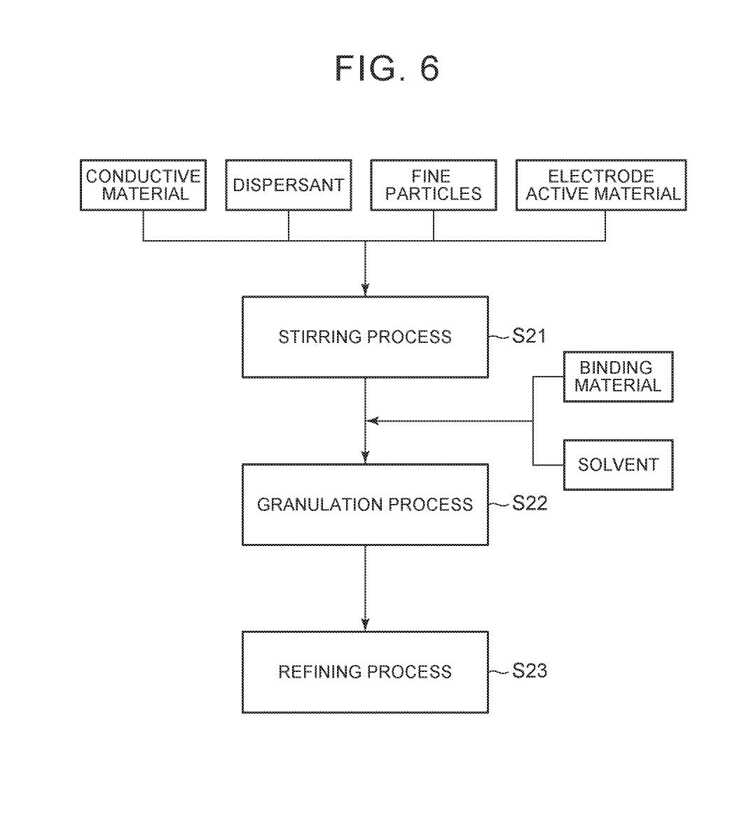

In addition, for comparison between the case in which the conductive material, the dispersant, and the fine particles were stirred in the first stirring process (Step S11) and the electrode active material was thereafter added thereto and stirred in the second stirring process (Step S12), and the case in which the conductive material, the dispersant, the fine particles, and the electrode active material were poured at a time and stirred, Sample 23 was manufactured according to the flowchart illustrated in FIG. 6.

When Sample 23 was manufactured, as illustrated in FIG. 6, first, the conductive material, the dispersant, the fine particles, and the electrode active material were poured into the stirrer, and were dry-stirred under the conditions of a peripheral speed of the stirring blades of 10 m/s and a time of 135 seconds (Step S21). Thereafter, the binding material and water were poured into the stirrer and were stirred for granulation under the conditions of a peripheral speed of the stirring blades of 10 m/s and a time of 15 seconds (Step S22). Finally, in order to refine the granules granulated in Step S22, stirring was performed thereon under the conditions of a peripheral speed of the stirring blades of 15 m/s and a time of 3 seconds (Step S23). As the materials (the conductive material, the dispersant, the fine particles, and the electrode active material) used to manufacture Sample 23, the same materials as those used to manufacture Sample 16 were used.

In Table 4 of FIG. 10, the malleability, film-forming properties, and cell IV characteristic of Sample 16 in which the electrode active material was separately (sequentially) poured (that is, the Sample manufactured by dividing the stirring process into the first stirring process and the second stirring process) and Sample 23 in which the electrode active material was simultaneously poured (that is, the Sample in which the stirring process was not divided) are shown.

As shown in Table 4 of FIG. 10, in Sample 23 in which the electrode active material was simultaneously poured, the malleability of the wet granules was not enhanced, and thus the film-forming properties were evaluated as unavailable. In contrast, in Sample 16 in which the electrode active material was separately (sequentially) poured, the malleability of the wet granules was enhanced, and the film-forming properties were good.

When the wet granules are manufactured, in order to crush the conductive material, the conductive material needs to be stirred at a high peripheral speed for a long period of time. Therefore, in a case where the conductive material, the dispersant, the fine particles, and the electrode active material were simultaneously poured as in Sample 23, in order to crush conductive material, the conductive material needs to be stirred for a long period of time in a state of containing the materials. At this time, the fine particles infiltrate into uneven portions of the surface of the electrode active material, and thus the fine particles cannot be uniformly dispersed in the periphery of the electrode active material. It is thought that the malleability of the wet granules in Sample 23 was not enhanced for this reason.

While the present invention has been described on the basis of the embodiment and Examples, the present invention is not limited only to the configurations of the embodiment and Examples, and naturally includes various changes, modifications, and combinations that can be made by those skilled in the art without departing from the scope of the inventions of the claims.

What is claimed is:

1. A method of manufacturing an electrode comprising:
forming wet granules by mixing a conductive material, an electrode active material, a binding material, and a solvent; and
forming an electrode mixture layer on an electrode current collector by rolling the wet granules, wherein
when the wet granules are formed, the conductive material and fine particles having a primary particle diameter of 20 nm or smaller are stirred and mixed with each other, and a stirred mixture and the electrode active material are stirred and mixed with each other, and
during the stirring when the wet granules are formed, a peripheral speed of a stirring blade included in a stirrer is 10 m/s or higher.

2. The method according to claim 1, wherein
an amount of the added fine particles is 0.05 wt % or more and 1 wt % or less with respect to the electrode active material.

3. The method according to claim 1, wherein
an amount of the added fine particles is 0.1 wt % or more and 0.5 wt % or less with respect to the electrode active material.

4. The method according to claim 1, wherein
during the stirring when the wet granules are formed, the peripheral speed of the stirring blade is 15 m/s or higher.

5. The method according to claim 1, wherein
the fine particles are alumina particles.
